(19) United States
(12) Patent Application Publication
(10) Pub. No.: US 2010/0078233 A1
(43) Pub. Date: Apr. 1, 2010

(54) Conveyance apparatus

(76) Inventors: Clarence Edgar Fletcher, Paulden, AZ (US); Eugene Ivan Lora, Paulden, AZ (US)

Correspondence Address: Ashok Tankha, 36 Greenleigh Drive, Sewell, NJ, 08080, US

(21) Appl. No.: 12/586,897

(22) Filed: Sep. 29, 2009

Related U.S. Application Data
(60) Provisional application No. 61/100,831, filed on Sep. 29, 2008.

(51) Int. Cl. B62D 51/06; B62B 1/16

(52) U.S. Cl. 180/19.1; 280/47.131

(57) ABSTRACT

A conveyance apparatus is provided for conveying goods and materials. The conveyance apparatus comprises a base element axially supported on a set of surface-engaging wheels driven by a driving element mounted on the base element, a central support member attached to the base element to leverage the conveyance apparatus off a ground surface about the horizontal axis of the base element, and harness elements mounted on the central support member. The harness elements comprise a first harness element and a configurable second harness element. The first harness element attaches to and suspends an extended section of a container containing the goods and materials and facilitates hoisting of the container using the leverage created by the central support member. The configurable second harness element secures and stabilizes the container. The conveyance apparatus is then selectively propelled by the driving element for conveying goods and materials easily and safely with minimal effort.

### CROSS REFERENCE TO RELATED APPLICATIONS

This application claims the benefit of provisional patent application No. 61/100,831 titled “Upright wheeled or tracked device that is powered by a low voltage motor”, filed on Sep. 29, 2008 in the United States Patent and Trademark Office.

### BACKGROUND

Household garbage and trash, including garden waste, kitchen waste, etc. need to be hauled from the place where the trash is generated to the location where the trash is disposed or picked up by a garbage removal company, for example, the curb-side adjacent to a house. Hauling trash containers, loose garbage and general refuse involves labor intensive manual pulling and pushing of a heavy garbage cart or wheeled equipment. Traditional equipment available for this job is designed to handle large volumes of trash and garbage and is also expensive. Smaller conveyance apparatuses utilized where the amount of trash is less than the trash generated by a business or apartment complex, for example, in a residence, etc., are generally moved manually and often require excessive effort and expose of risk of injury to the user. Furthermore, such trash containers need to be physically lifted onto a conveyance apparatus before hauling. Such apparatuses for hauling trash containers and loose garbage to the curb for disposal are therefore unsuitable for the elderly, handicapped, and others with limited physical strength. Hence, there is a need for a conveyance apparatus that is inexpensive, small in size, and easily maneuverable than traditional equipment to easily handle the tasks of moving trash containers and waste material for the above users.

There is also a need to provide a mechanism for reducing the effort required to move the trash container off the ground onto the conveyance apparatus. Furthermore, standard molded trash containers used by homeowners, conveyed in currently available conveyance apparatuses are prone to tipping over. Therefore, there is a need to also secure and stabilize the trash containers to an apparatus to prevent the trash container from tipping over.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The conveyance apparatus and method disclosed herein addresses the above stated needs for safe and easy handling and conveying of goods and materials with minimal effort and fatigue. The conveyance apparatus disclosed herein comprises a base element axially supported on a set of surface-engaging wheels, a central support member, and multiple harness elements. The set of surface-engaging wheels is driven by a driving element mounted on the base element. The driving element is, for example, a low voltage electric propulsion motor. The driving element has a driving connection with the base element and powers the set of surface-engaging wheels through the base element. The central support member is attached to the base element at a second end of the central support member to leverage the conveyance apparatus off a ground surface about a horizontal axis of the base element. The horizontal axis forms a pivot line. The harness elements are mounted on the central support member. The harness elements comprise, for example, a first harness element and a second harness element. The first harness element is mounted on a first section of the central support member proximal to the first end of the central support member. The first harness element attaches to and suspends an extended section of a container containing the goods and materials using the leverage created by the central support member. The second harness element is mounted on a second section of the central support member proximal to a second end of the central support member. The second harness element secures and stabilizes the container which contains the goods and materials.

In an embodiment, the first harness element comprises, for example, a pair of extended hooks supported on a cross bar. The cross bar is rigidly attached to the first section of the central support member. The extended hooks engage the extended section of the container to facilitate hoisting of the container off the ground surface. In another embodiment, the first harness element comprises, for example, a bracket rigidly attached to the cross bar for engaging a top rim of the container to facilitate the hoisting of the container off the ground surface.

In an embodiment, the second harness element comprises, for example, a slidably expandable bracket and a stem. The second harness element is configurable to accommodate containers of different shapes and sizes. The stem rigidly connects the slidably expandable bracket to the central support member for providing a back support to the container for preventing swaying of the container.

The conveyance apparatus further comprises multiple control elements mounted on the central support member for controlling operation and motion of the conveyance apparatus. The control elements are, for example, a power trigger, a change over switch, a keyed safety switch, etc. The keyed safety switch safeguards the conveyance apparatus against misuse by a user. The power trigger activates the driving element. The change over switch enables changing direction of motion of the conveyance apparatus.

The conveyance apparatus further comprises an energy generating device mounted proximal to the first end of the central support member to charge an energy storage device mounted proximal to the second end of the central support member. The energy storage device energizes the driving element to drive the conveyance apparatus.

In an embodiment, the conveyance apparatus comprises a selector switch mounted on the support bracket to facilitate selection of speed of the driving element, thereby enabling a user to select a desired speed. In another embodiment, the conveyance apparatus comprises an overload cut-out switch mounted on the energy storage device, which safeguards the conveyance apparatus against overloading, by cutting out energy to the driving element when the load carried on the conveyance apparatus exceeds a predetermined limit. In yet another embodiment, the conveyance apparatus comprises a display element mounted on the energy generating device, which indicates insufficient power in the energy storage device to run the driving element. The display element thus prompts the user to charge the energy storage device using the energy generating device.

The conveyance apparatus further comprises a parking element and a braking element. The parking element is rigidly attached to the slidably expandable bracket of the second harness element for parking the conveyance apparatus. The braking element is spring-loaded and attached to the base element for inhibiting rotation of the set of surface-engaging wheels equally. In an embodiment, a plate is detachably attached to the base element using fasteners for supporting the container and the goods and materials.

The conveyance apparatus is selectively propelled by the driving element for conveyance goods and materials safely and with minimal effort.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 exemplarily illustrates a rear side perspective view of a conveyance apparatus showing a container suspended from a first harness element and secured to a configurable second harness element of the conveyance apparatus.

FIG. 2 exemplarily illustrates a side orthogonal view of the conveyance apparatus showing a container suspended from the first harness element of the conveyance apparatus.

FIG. 3 exemplarily illustrates a side orthogonal view of the conveyance apparatus showing a container suspended from the first harness element of the conveyance apparatus and hoisted and secured against a second harness element.

FIG. 4 exemplarily illustrates a top orthogonal view of the conveyance apparatus.

FIG. 5 exemplarily illustrates a bottom orthogonal view of the conveyance apparatus.

FIG. 6 exemplarily illustrates a rear orthogonal view of the conveyance apparatus.

FIG. 7 exemplarily illustrates a side orthogonal view of the conveyance apparatus.

FIG. 8 exemplarily illustrates a front orthogonal view of the conveyance apparatus.

FIG. 9 exemplarily illustrates a side orthogonal view of the conveyance apparatus.

FIG. 10 exemplarily illustrates a cut-away front perspective view of the conveyance apparatus showing an exploded view of a detachable plate.

FIG. 11 exemplarily illustrates a cut-away front perspective view of a conveyance apparatus showing a detachable plate attached to the base element of the conveyance apparatus using a pair of fasteners.

FIG. 12 exemplarily illustrates a top orthogonal view of the conveyance apparatus, showing a locking element of the conveyance apparatus.

FIG. 13 exemplarily illustrates a method of conveying goods and materials.

### DETAILED DESCRIPTION OF THE INVENTION

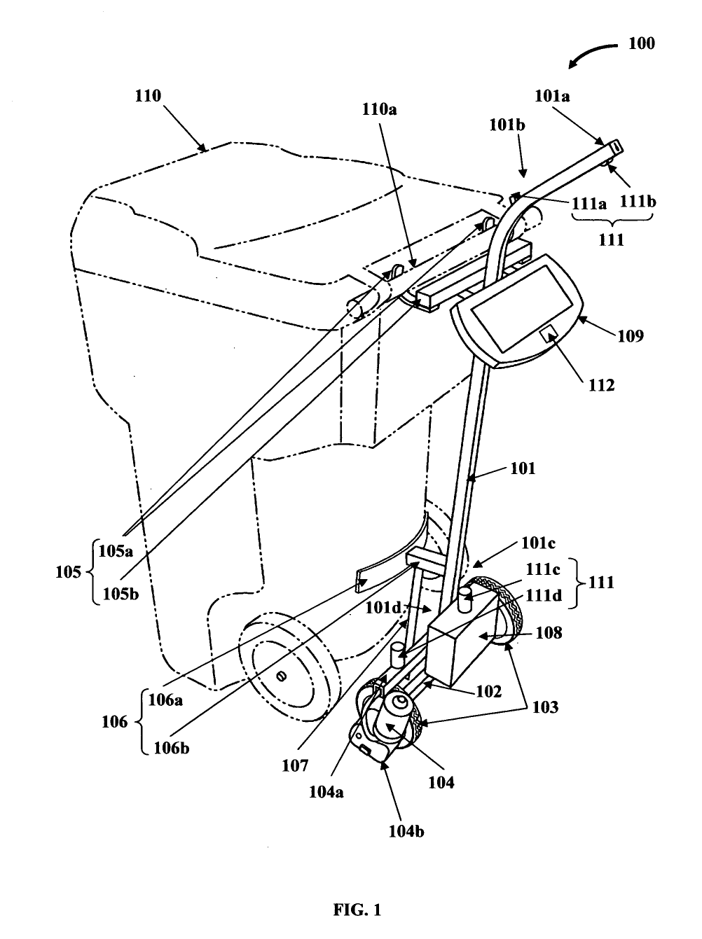

FIG. 1 exemplarily illustrates a rear side perspective view of a conveyance apparatus 100 showing a container 110 suspended from a first harness element 105 and secured to a second harness element 106 of the conveyance apparatus 100 for conveying goods and materials. In an embodiment, the conveyance apparatus 100 is powered by an electric propulsion motor. The conveyance apparatus 100 comprises a base element 102, a set of surface-engaging wheels 103, a central support member 101, and multiple harness elements 105 and 106 as disclosed above. The base element 102 is axially supported on the set of surface-engaging wheels 103. The wheels 103 engage surfaces, for example, ground surfaces, platforms, etc. The set of surface-engaging wheels 103 are optionally driven by a driving element 104 mounted on the base element 102. In an embodiment, the set of surface-engaging wheels 103 may be driven at variable speeds. The driving element 104 is, for example, a gear head electric motor. The central support member 101 is attached to the base element 102 at a second end 101d of the central support member 101 to leverage the conveyance apparatus 100 off a ground surface about the base element 102 to facilitate lifting the container 110 off the ground. The central support member 101 and the base element 102, are, for example, made of a metal, for example, an aluminum alloy, steel, etc.

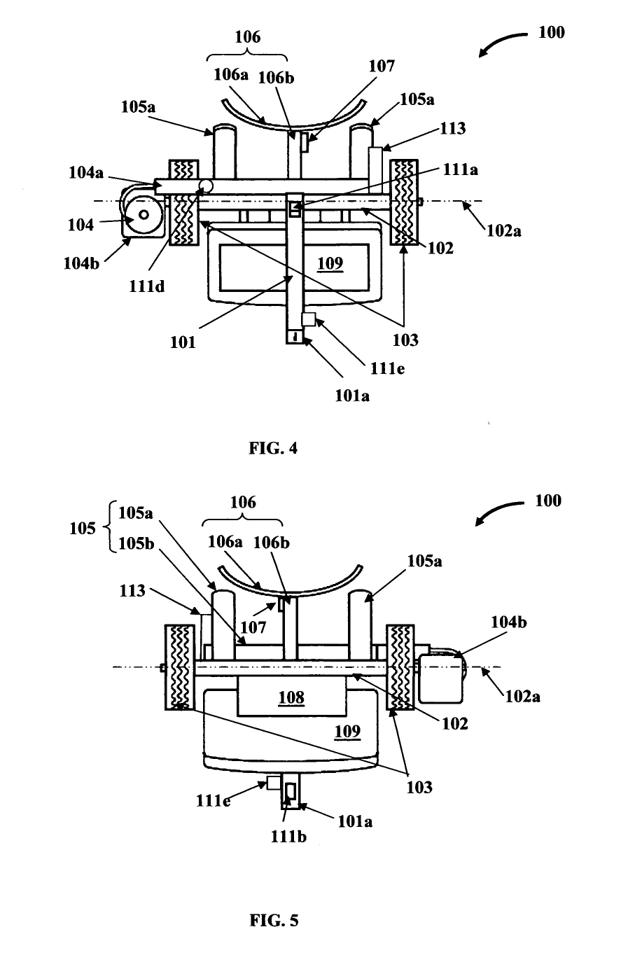

The harness elements 105 and 106 of the conveyance apparatus 100 are mounted on multiple sections 101b and 101c on the central support member 101. The harness elements 105 and 106 comprise, for example, a first harness element 105 and a second harness element 106. The first harness element 105 is mounted on a first section 101b of the central support member 101 proximal to the first end 101a of the central support member 101. The first section 101b of the central support member 101 is a generally angled section as exemplarily illustrated in FIGS. 1-3, FIG. 7 and FIG. 9. The first harness element 105 attaches to an extended section 110a of the container 110 to facilitate tilting the container 110 with respect to its vertical axis or suspending the container 110 that contains goods and materials, and thus facilitates hoisting of the container 110 off the ground surface using the leverage created by the central support member 101 about a pivot line defined by a horizontal axis 102a of the base element 102 as exemplarily illustrated in FIGS. 4-6, FIG. 8, FIGS. 10-12. The conveyance apparatus 100 is leveraged off the ground surface about the horizontal axis 102a of the base element 102.

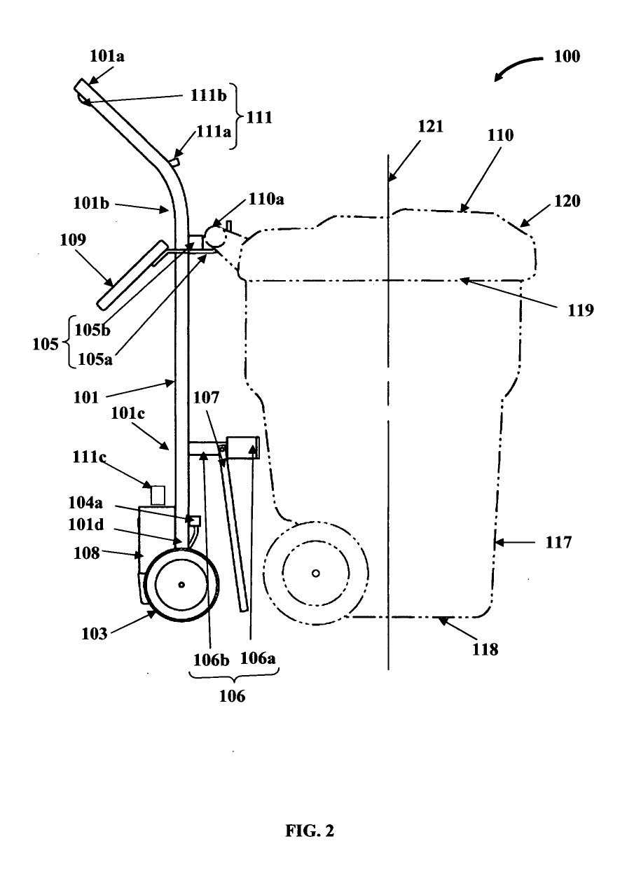

As shown by FIG. 2, the container 110 has a side wall 117, a bottom 118 attached to the side wall 117 and a top 119. The top 119 is open to allow access to the interior volume of the container 110. The open top 119 of the container 110 is selectably closed by a lid 120. The container 110 also defines a longitudinal axis 121 that is generally normal to the open top 119. The extended section 110a is elongated and is oriented so that its long dimension is generally normal and in a spaced apart relation to the longitudinal axis 121 of the container 110.

In an embodiment, the first harness element 105 comprises, for example, a pair of extended hooks 105a supported on a cross bar 105b. The cross bar 105b is rigidly attached to the first section 101b of the central support member 101. The extended hooks 105a engage the extended section 110a of the container 110 to facilitate tilting or hoisting of the container 110 off the ground surface. A side orthogonal view of the conveyance apparatus 100 showing a container 110 suspended from the first harness element 105 of the conveyance apparatus 100 is exemplarily illustrated in FIG. 2. In another embodiment, the first harness element 105 comprises, for example, a bracket (not shown) rigidly attached to the cross bar 105b for engaging a top rim of the container 110 to facilitate the hoisting of the container 110 off the ground surface. The first harness element 105 is, for example, made of steel.

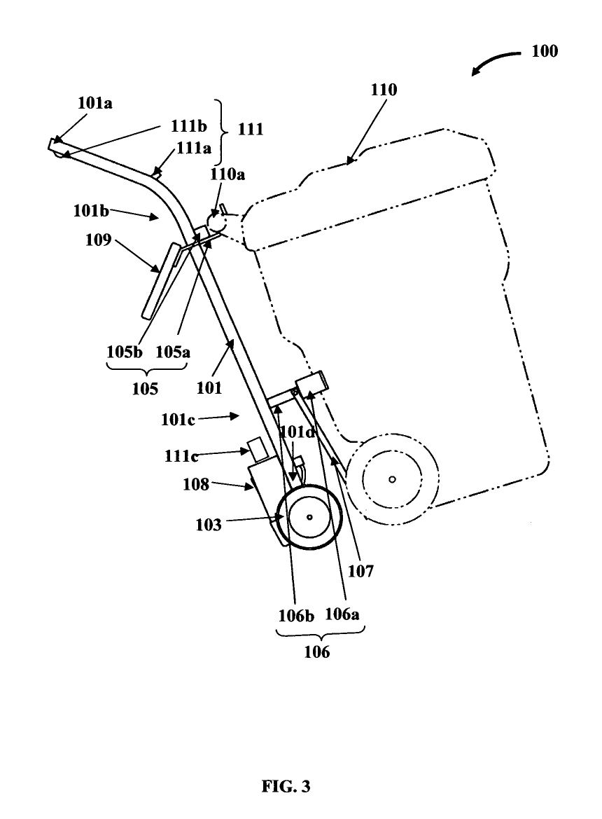

The second harness element 106 is mounted on a second section 101c of the central support member 101 proximal to the second end 101d of the central support member 101. The second section 101c of the central support member 101 is elongated for providing additional leverage for tipping the conveyance apparatus 100 about the pivot line defined by the horizontal axis 102a of the base element 102, and for tilting or hoisting the container 110 off the ground surface. The second harness element 106 secures and stabilizes the container 110 which contains the goods and materials. In an embodiment, the second harness element 106 comprises, for example, a slidably expandable bracket 106a and a stem 106b. The second harness element 106 is slidably expandable, and therefore configurable to accommodate containers 110 of different shapes and sizes. The configurable second harness element 106 can therefore be secured to a container 110 of different shapes and sizes. The stem 106b rigidly connects the slidably expandable bracket 106a to the central support member 101 for providing a back support to the container 110 for preventing swaying of the container 110. The second harness element 106 is, for example, made of steel. A side orthogonal view of the conveyance apparatus 100 showing a container 110 tilted or suspended from the first harness element 105 of the conveyance apparatus 100 and hoisted and secured against the second harness element 106 is exemplarily illustrated in FIG. 3.

The conveyance apparatus 100 further comprises multiple control elements 111 mounted on the central support member 101 for controlling operation and motion of the conveyance apparatus 100. The control elements 111 are, for example, electronic control elements. The control elements 111 are, for example, a keyed safety switch 111e, a power trigger 111a, a change over switch 111b, etc. The keyed safety switch 111e safeguards the conveyance apparatus 100 against misuse by a user. As used herein, the term “user” refers to a home owner, garbage collector or other person who uses the conveyance apparatus 100 to handle and convey goods and materials from a starting point to a destination, for example, from the kitchen, garden, etc. to the curb. The power trigger 111a activates the driving element 104. The user may, for example, place goods and materials in a container 110 and suspend the container 110 on the conveyance apparatus 100 using the first harness element 105 and use the power trigger 111a to activate the driving element 104 to power the conveyance apparatus 100. The change-over switch 111b enables changing the direction of motion of the conveyance apparatus 100. The user may, for example, use the change over switch 111b to move the conveyance apparatus 100 in a desired direction. The power trigger 111a, the change over switch 111b, and the keyed safety switch 111e are, for example, mounted on the first section 101b or the first end 101a of the central support member 101 as exemplarily illustrated in FIGS. 1-3, FIG. 7 and FIG. 9.

FIG. 4 exemplarily illustrates a top orthogonal view of the conveyance apparatus 100. As illustrated in FIG. 4, the driving element 104 has a driving connection 104b with the base element 102 and is rigidly attached to the central support member 101 through a support bracket 104a. The driving element 104 powers the set of surface-engaging wheels 103 through the base element 102. The driving connection 104b may, for example, be a gear drive of a gear motor.

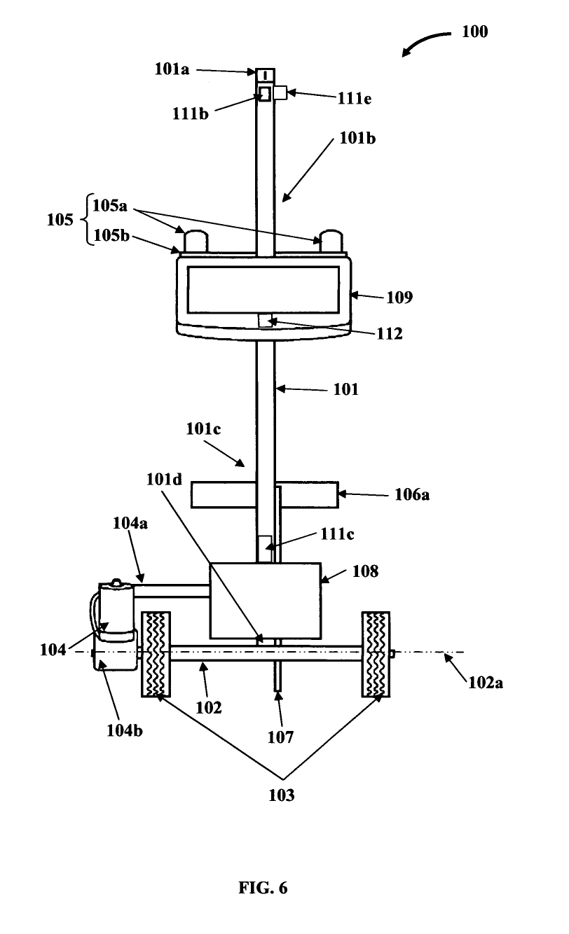

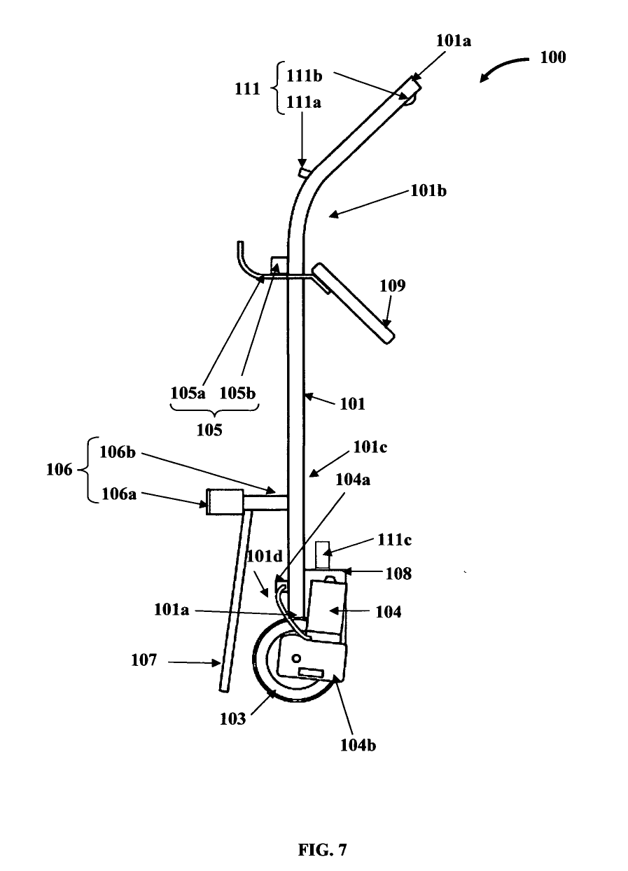

FIG. 5 exemplarily illustrates a bottom orthogonal view of the conveyance apparatus 100. As illustrated in FIG. 5, the conveyance apparatus 100 further comprises an energy generating device 109 mounted proximal to the first end 101a of the central support member 101 to charge an energy storage device 108 mounted proximal to the second end 101d of the central support member 101. The energy generating device 109 is, for example, a solar panel. The energy storage device 108 is, for example, a rechargeable battery. The energy storage device 108 may be charged by other means, for example, by plugging the conveyance apparatus 100 into the mains. The energy storage device 108 energizes the driving element 104 to drive the conveyance apparatus 100. A rear orthogonal view of the conveyance apparatus 100 is exemplarily illustrated in FIG. 6.

In another embodiment, the conveyance apparatus 100 comprises a selector switch 111d mounted on, for example, the support bracket 104a, as exemplarily illustrated in FIG. 1 and FIG. 4, to facilitate selection of speed of the driving element 104, thereby enabling a user to select a desired speed, for example, slow speed or walking speed. In another embodiment, the conveyance apparatus 100 comprises an overload cut-out switch 111c mounted on, for example, the energy storage device 108 as exemplarily illustrated in FIGS. 1-3 and FIGS. 6-11, The overload cut-out switch 111c safeguards the conveyance apparatus 100 against overloading, by cutting off energy to the driving element 104 when the load carried on the conveyance apparatus 100 exceeds a predetermined limit. In yet another embodiment, the conveyance apparatus 100 comprises a display element 112 mounted on the energy generating device 109, for indicating an event of insufficient power in the energy storage device 108 to run the driving element 104. The display element 112 thus prompts the user to charge the energy storage device 108, for example, by using the energy generating device 109, plugging the conveyance apparatus 100 into the mains, etc.

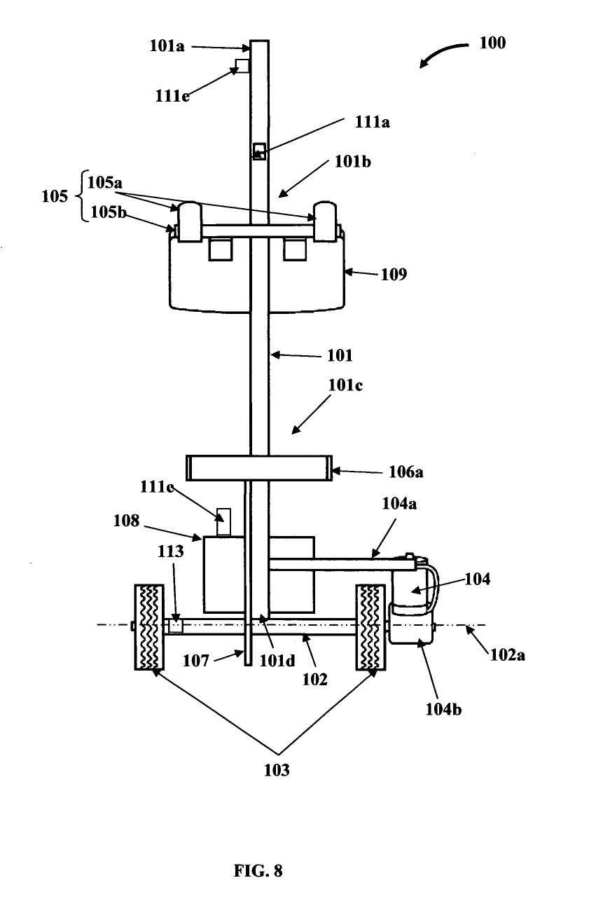

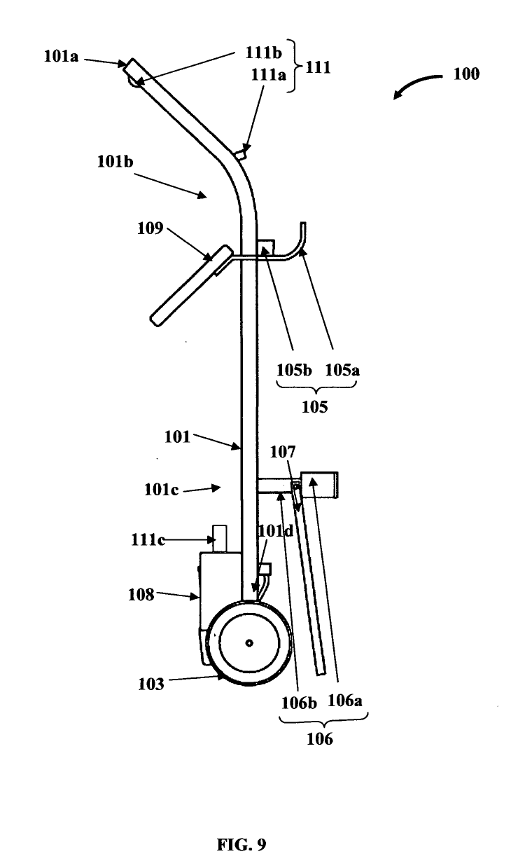

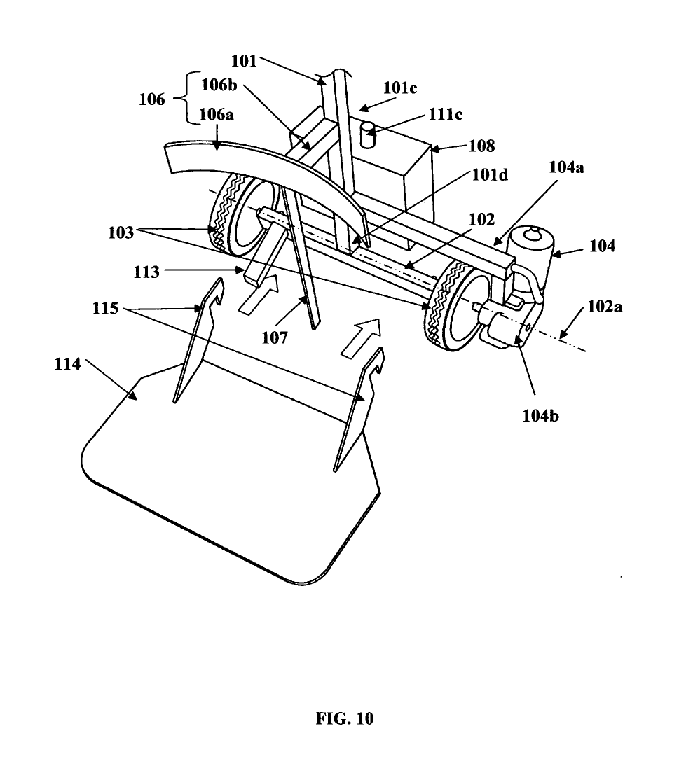

FIG. 7 exemplarily illustrates a side orthogonal view of the conveyance apparatus 100. As illustrated in FIG. 7, the conveyance apparatus 100 further comprises a parking element 107 rigidly attached to the slidably expandable bracket 106a of the second harness element 106 for parking the conveyance apparatus 100. A front orthogonal view and a side orthogonal view of the conveyance apparatus 100 are exemplarily illustrated in FIG. 8 and FIG. 9 respectively.

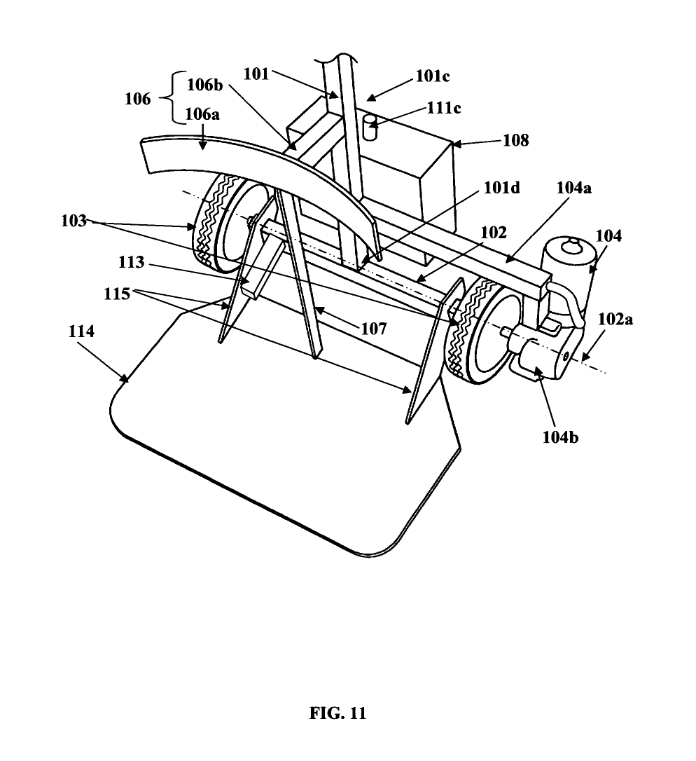

FIG. 10 exemplarily illustrates a cut-away front perspective view of the conveyance apparatus 100 showing an exploded view of a detachable plate 114. The conveyance apparatus 100 further comprises a plate 114 detachably attached to the base element 102 using fasteners 115. The plate 114 is used for supporting the container 110 and the goods and materials. A cut-away front perspective view of the conveyance apparatus 100 showing a detachable plate 114 attached to the base element 102 of the conveyance apparatus 100 using a pair of fasteners 115 is exemplarily illustrated in FIG. 11.

In an embodiment, the conveyance apparatus 100 further comprises a spring-loaded braking element 113 mounted on the base element 102 for inhibiting rotation of the set of surface-engaging wheels 103, as exemplarily illustrated in FIGS. 10-11. The braking element 113 is operable locally by foot of the user to inhibit rotation of the set of surface-engaging wheels 103 equally. Furthermore, when the user thus inhibits the rotation of the set of surface-engaging wheels 103, the braking element 113 simultaneously shuts off energy to the driving element 104 from the energy storage device 108, thus facilitating quick and smooth stopping of the conveyance apparatus 100. When the user next releases the braking element 113 from under the foot, the spring loading enables the braking element 113 to regain the earlier running position and the conveyance apparatus 100 resumes its motion.

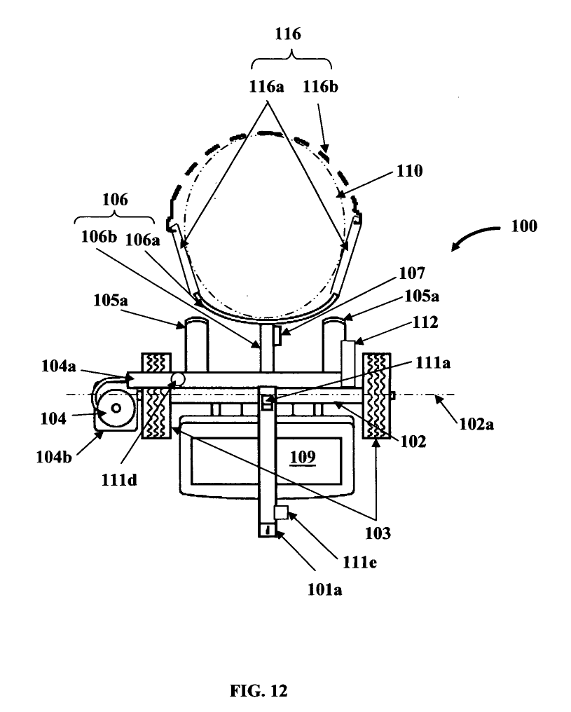

FIG. 12 exemplarily illustrates a top orthogonal view of the conveyance apparatus 100, showing a locking element 116 of the conveyance apparatus 100. The locking element 116 is, for example, mounted on the second harness element 106 of the conveyance apparatus 100. The locking element 116 locks the container 110 securely to the second harness element 106 to prevent the container 110 from slipping off when the conveyance apparatus 100 moves down a slope, or from tipping to one side with respect to the vertical axis of the central support member 101. The locking element 116 comprises a pair of opposing connectors 116a detachably attached to the slidably expandable bracket 106a of the second harness element 106 and a spring 116b attached to the connectors 116a, as exemplarily illustrated in FIG. 12. The locking element 116 is configurable to accommodate containers of different shapes and sizes, by stretching the spring 116b around the respective containers.

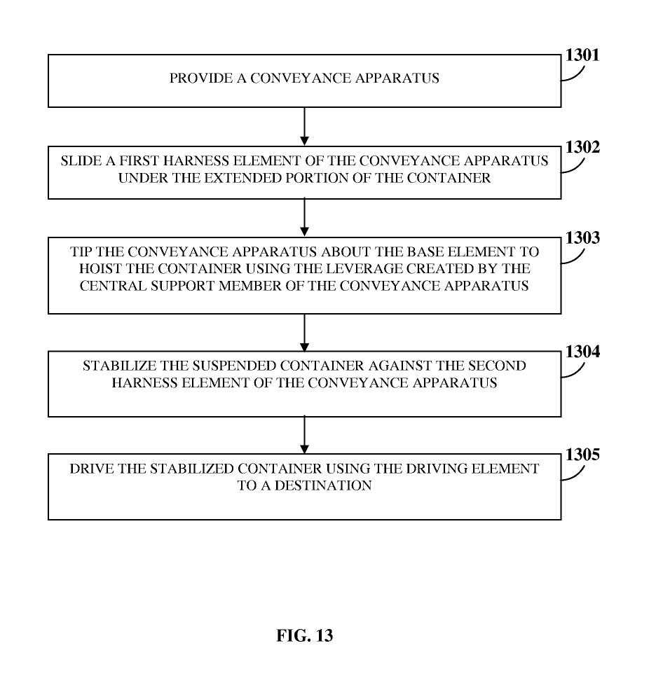

FIG. 13 exemplarily illustrates a method of conveying goods and materials. A conveyance apparatus 100 as disclosed in the detailed description of FIGS. 1-12 is provided 1301. The first harness element 105 of the conveyance apparatus 100 is slid 1302 under the extended section 110a, for example, the handle, of the container 110 and tipped 1303 about the base element 102 to tilt or hoist the container 110 off the ground surface using the leverage created by the central support member 101 as exemplarily illustrated in FIG. 3. The container 110 is suspended from the first harness element 105. The suspended container 110 is stabilized 1304 against the second harness element 106 of the conveyance apparatus 100. After stabilizing the suspended container 110, the container 110 may be locked securely to the second harness element 106 of the conveyance apparatus 100 using the locking element 116 mounted on the second harness element 106 of the conveyance apparatus 100 as disclosed in the detailed description of FIG. 12. The user adjusts the control elements 111 based on preferences to control the operation and motion of the conveyance apparatus 100 and then drives 1305 the stabilized container 110 using the driving element 104 to a destination for conveying the stabilized container 110 containing the goods and materials.

The foregoing examples have been provided merely for the purpose of explanation and in no way are to be construed as limiting of the present invention. While the invention has been described with reference to various embodiments, it is understood that the words, which have been used herein, are words of description and illustration, rather than words of limitation. Additionally, although the invention has been described herein with reference to particular means, materials and embodiments, the invention is not intended to be limited to the particulars disclosed herein; rather, the invention extends to all functionally equivalent structures, methods and uses, such as are within the scope of the appended claims. It will be appreciated by those skilled in the art, having the benefit of the teachings of this specification, that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A conveyance apparatus for conveying goods and materials, comprising:
a container, said container having a side wall, a bottom and a top, said top of said container being open, said top of said container being selectably closed by a lid, said container being configured to receive and to contain said goods and materials, said side wall defining an elongated extended section, said container having a longitudinal axis, said extended section being located generally normal to and in a spaced apart relation from said container longitudinal axis;
a base element axially supported on a set of surface-engaging wheels;
a central support member attached to said base element at a second end of said central support member to leverage said container off a ground surface about a horizontal axis of said base element, wherein said horizontal axis forms a pivot line;
a plurality of harness elements mounted on said central support member, wherein said harness elements comprise:
a first harness element mounted on a first section of said central support member proximal to a first end of said central support member, wherein said first harness element attaches to and suspends said extended section of said container using said leverage created by said central support member, wherein said first harness element comprises a pair of extended hooks supported on a cross bar, wherein said cross bar is rigidly attached to said first section of said central support member, wherein said extended hooks engage said extended section of said container to facilitate hoisting of said container off said ground surface; and
a second harness element mounted on a second section of said central support member proximal to said second end of said central support member, wherein said second harness element engages said side wall of said container, and wherein said second harness element comprises a slidably expandable bracket and a stem, wherein said stem rigidly connects said slidably expandable bracket to said central support member, and wherein said connected slidably expandable bracket provides a back support to said container for preventing swaying of said container.

2. A conveyance apparatus for conveying goods and materials, comprising:
a base element axially supported on a set of surface-engaging wheels;
a central support member attached to said base element at a second end of said central support member to leverage said conveyance apparatus off a ground surface about a horizontal axis of said base element, wherein said horizontal axis forms a pivot line;
a plurality of harness elements mounted on said central support member, wherein said harness elements comprise:
a first harness element mounted on a first section of said central support member proximal to a first end of said central support member, wherein said first harness element attaches to and suspends an extended section of a container containing said goods and materials using said leverage created by said central support member, and wherein said first harness element comprises a bracket rigidly attached to a cross bar, said bracket being configured to engage a top rim of said container to facilitate said hoisting of said container off said ground surface, wherein said cross bar is rigidly attached to said first section of said central support member; and
a second harness element mounted on a second section of said central support member proximal to said second end of said central support member, wherein said second harness element secures and stabilizes said container containing said goods and materials, and wherein said second harness element comprises a slidably expandable bracket and a stem, wherein said stem rigidly connects said slidably expandable bracket to said central support member, and wherein said connected slidably expandable bracket provides a back support to said container for preventing swaying of said container.

3. The conveyance apparatus of claim 1, further comprising a driving element for driving said set of surface-engaging wheels mounted on said base element, wherein said driving element has a driving connection with said base element, wherein said driving element is a motor configured to rotate said set of surface-engaging wheels.

4. The conveyance apparatus of claim 3, further comprising a plurality of control elements mounted on said central support member for controlling operation and motion of said conveyance apparatus, said plurality of control elements being operably connected to said driving element.

5. The conveyance apparatus of claim 4, wherein one of said control elements is a selector switch configured to select a speed of said motor.

6. The conveyance apparatus of claim 4, wherein one of said control elements is a power trigger configured to selectably activate said driving element.

7. The conveyance apparatus of claim 4, wherein one of said control elements is a change-over switch configured to change a direction of movement of said driving element and the conveyance apparatus.

8. The conveyance apparatus of claim 1, further comprising an energy generating device mounted proximal to said first end of said central support member to charge an energy storage device mounted proximal to said second end of said central support member, wherein said energy storage device energizes said driving element to drive said conveyance apparatus.

9. The conveyance apparatus of claim 1, further comprising a parking element rigidly attached to said slidably expandable bracket of said second harness element for parking said conveyance apparatus.

10. The conveyance apparatus of claim 1, wherein said second harness element is configurable to secure said container of a plurality of sizes and shapes.

11. The conveyance apparatus of claim 1, further comprising a braking element for inhibiting rotation of said set of surface-engaging wheels equally.

12. The conveyance apparatus of claim 1, further comprising a locking element mounted on said second harness element of the conveyance apparatus for locking said container securely to said second harness element of the conveyance apparatus.

13. The conveyance apparatus of claim 1, further comprising a plate detachably attached to said base element using fasteners for supporting one or more of said container and said goods and materials.

14. A method of conveying goods and materials, comprising:
providing a conveyance apparatus comprising:
a base element axially supported on a set of surface-engaging wheels;
a central support member attached to said base element at a second end of said central support member to leverage said conveyance apparatus off a ground surface about a horizontal axis of said base element;
a plurality of harness elements mounted on said central support member, wherein said harness elements comprise:
a first harness element mounted on a first section of said central support member proximal to a first end of said central support member, wherein said first harness element attaches to and suspends an extended section of a container containing said goods and materials, wherein said first harness element comprises a pair of extended hooks supported on a cross bar, wherein said cross bar is rigidly attached to said first section of said central support member, wherein said extended hooks engage said extended section of said container to facilitate hoisting of said container off said ground surface using said leverage created by said central support member; and
a second harness element mounted on a second section of said central support member proximal to said second end of said central support member, wherein said second harness element secures and stabilizes said container containing said goods and materials;
sliding said first harness element of said conveyance apparatus under said extended section of said container and tipping said conveyance apparatus about said base element to hoist said container using said leverage created by said central support member about said horizontal axis of said base element, wherein said container is suspended from said first harness element;
stabilizing said suspended container against said second harness element of said conveyance apparatus; and
driving said stabilized container using a driving element to a destination for conveying said stabilized container containing said goods and materials.

15. The method of claim 14, wherein said first harness element further comprises a bracket rigidly attached to said cross bar for engaging a top rim of said container to facilitate said hoisting of said container off said ground surface.

16. The method of claim 14, wherein said second harness element comprises a slidably expandable bracket and a stem, wherein said stem rigidly connects said slidably expandable bracket to said central support member, and wherein said connected slidably expandable bracket provides a back support to said container for preventing swaying of said container.

17. The method of claim 14, wherein said driving element has a driving connection with said base element, wherein said driving element powers said set of surface-engaging wheels through said base element.

18. The method of claim 14, further comprising controlling operation and motion of said conveyance apparatus using a plurality of control elements mounted on said central support member.

19. The method of claim 14, further comprising locking said container securely to said second harness element of the conveyance apparatus using a locking element mounted on said second harness element of the conveyance apparatus.

20. The method of claim 14, further comprising providing an energy generating device mounted proximal to said first end of said central support member to charge an energy storage device mounted proximal to said second end of said central support member, wherein said energy storage device energizes said driving element to drive said conveyance apparatus.
